(19) United States
(12) Patent Application Publication
(10) Pub. No.: US 2019/0179569 A1
(43) Pub. Date: Jun. 13, 2019

(54) DATA STORAGE DEVICE AND DATA STORAGE METHOD

(71) Applicant: Shannon Systems Ltd., Shanghai (CN)

(72) Inventor: Xueshi YANG, Cupertino, CA (US)

(21) Appl. No.: 16/052,846

(22) Filed: Aug. 2, 2018

(30) Foreign Application Priority Data
Dec. 7, 2017 (CN) 201711283964.1

(51) Int. Cl. G06F 3/06; G06F 12/10; G06F 12/02

(52) U.S. Cl. CPC G06F 3/0659; G06F 3/0604; G06F 3/0616; G06F 3/0679; G06F 2212/7205; G06F 12/0253; G06F 2212/1036; G06F 2212/7201; G06F 12/10

(57) ABSTRACT

A data storage device includes a plurality of flash memories and at least one controller. Each of the flash memories includes a plurality of blocks. The controller operates the flash memories to access data in a plurality of working modes. The working mode of each flash memory is mutually independent. When the data storage device receives a control command from an application layer, the controller applies one of the working modes to one of the flash memories during operation, or switches the working mode of one of the flash memories during operation according to the control command.

### CROSS REFERENCE TO RELATED APPLICATIONS

This Application claims priority of China Patent Application No. 201711283964.1 filed on Dec. 07, 2017, the entirety of which is incorporated by reference herein.

### BACKGROUND OF THE INVENTION

### Field of the Invention

The disclosure generally relates to a data storage device and a data storage method, and more particularly, to a data storage device and a data storage method that can switch between working modes.

### Description of the Related Art

Flash memory is a general non-volatile data storage device which performs erasing and programming electrically. For example, NAND flash is often used in memory cards, USB flash devices, SSD, eMMC, UFS, and so on.

However, the data storage device could be switched between different working modes based on the needs of the user. How to switch the working mode rapidly and efficiently is an important issue in the field of data storage. Therefore, a data storage device and a data storage method for rapidly and efficiently switching the working mode are needed.

### BRIEF SUMMARY OF THE INVENTION

In order to solve the above problem, the present invention provides a data storage device and a data storage method to switch the working mode rapidly and conveniently based on the needs of the user.

The present invention provides a data storage device including a plurality of flash memories and at least one controller. Each of the flash memories comprises a plurality of blocks. The controller operates the flash memories to access data in a plurality of working modes. The working mode of each flash memory is mutually independent. When the data storage device receives a control command from an application layer, the controller applies one of the working modes to one of the flash memories during operation, or switches the working mode of one of the flash memories during operation according to the control command.

Specifically, the working mode includes a read-only mode, a write-only mode, a garbage collection off mode, a garbage collection switching mode, a garbage collection parameter modification mode, a wear-leveling off mode or an over-provisioning parameter modification mode. The controller stores at least one mapping table to record mapping information between the flash memory and a plurality of logical addresses. When the read-only mode is applied to the flash memory, the controller does not amend the mapping table related to the flash memory; and when the write-only mode is applied to the flash memory, the controller amends the mapping table related to the flash memory. The garage collection close mode does not initiate or stop execution of a garbage collection procedure. The wear-leveling close mode does not initiate or stop execution of a wear-leveling procedure. The garbage collection switch mode is utilized to switch an algorithm which is adopted by a garbage collection procedure. The garbage collection parameter modification mode is utilized to adjust a predetermined value which is referred by a garbage collection procedure. The over-provisioning parameter modification mode is utilized to adjust the data storage capacity for over provisioning. The controller applies one of the working modes to one of the flash memories during operation according to the control command, or switches the working mode of one of the flash memories during operation according to the control command. The data storage device further includes a host driver arranged between the controller and the application layer. The host driver is utilized to apply one of the working modes to one of the flash memories during operation or switch the working mode of one of the flash memories during operation according to the control command.

The present invention provides a data storage method applied to a data storage device. The data storage device includes a plurality of flash memories and at least one controller. The data storage method includes arranging the flash memories to access data at a plurality of working modes, wherein the working mode of each flash memory is mutually independent; determining whether the data storage device receives a control command from an application layer or not; and when receiving the control command, applying one of the working modes on one of the flash memories during operation, or switching the working mode of one of the flash memories during operation according to the control command.

Other aspects and features of the present invention will become apparent to those with ordinarily skill in the art upon review of the following descriptions of specific embodiments of the data storage device and the data storage method.

### BRIEF DESCRIPTION OF DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a block diagram illustrating the data storage device and the application layer according to an embodiment of the invention;

FIG. 2 is a schematic diagram illustrating the flash memory according to an embodiment of the invention;

FIG. 3 is a block diagram illustrating the data storage device and the application layer according to another embodiment of the invention;

FIG. 4 is a block diagram illustrating the data storage device and the application layer according to another embodiment of the invention;

FIG. 5 is a process flow illustrating the data storage method according to an embodiment of the invention.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

There are various forms of nonvolatile memory used in data storage devices for long-term data retention, such as flash memory, magneto-resistive RAM, ferroelectric RAM, resistive RAM, spin transfer torque-RAM (STT-RAM), and so on. The flash memory will be used as an example for illustration in the following description, but it is not limited thereto.

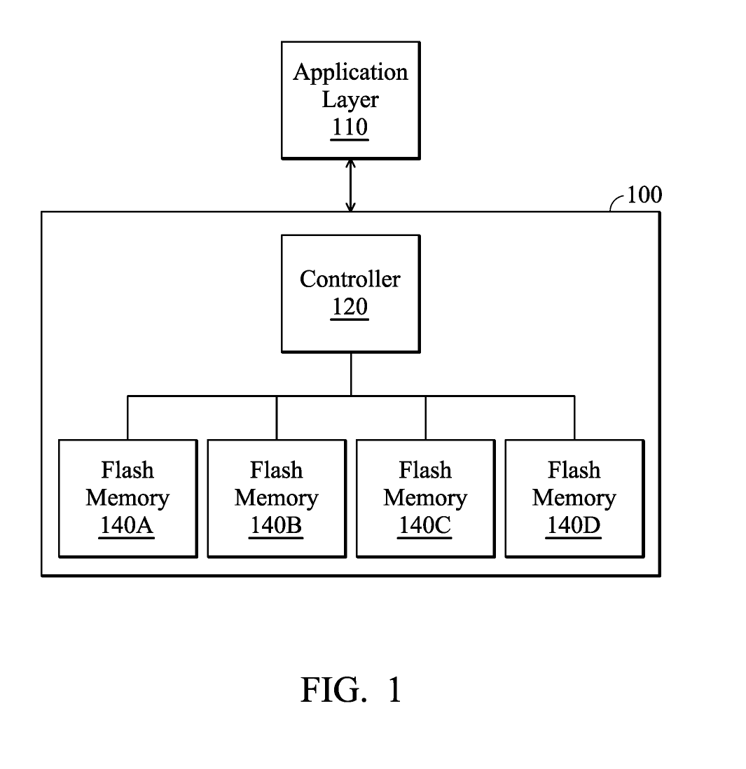

FIG. 1 is a block diagram illustrating the data storage device 100 and the application layer 110 according to an embodiment of the invention. The data storage device 100 complies with the embedded MultiMediaCard (eMMC) standard, the Universal Flash Storage (UFS) standard, the Non-Volatile Memory express (NVMe) standard, the Advanced Technology Attachment (ATA) standard, the Parallel ATA (PATA) standard, the Serial ATA (SATA) standard or the Small Computer System Interface (SCSI) standard.

As shown in FIG. 1, the data storage device 100 includes a controller 120 and several flash memories 140A˜140D. Four channels are arranged between the controller 120 and the flash memories 140A˜140D to perform the transmission or allocation of data. The working modes of the flash memories 140A˜140D could be identical or could be independent to each other. When they are independent to each other, changing or switching the working mode of a flash memory during the on-the-fly period will not affect the working modes of other flash memories. In addition, the changing or switching on the working mode during the on-the-fly period will become effective immediately without re-initiating to change or switch on the working mode. Furthermore, the data storage device 100 is coupled to the application layer 110 of the host to receive the control command transmitted by the application layer 110. It should be noted that the number of channels, the data transmission and the data allocation are used for illustration, not for limiting the present invention. People skilled in the art could arrange for a different number of channels and data allocation which is not beyond the scope and spirit of the present invention.

Specifically, the controller 120 is utilized by the data storage device 100 to communicate with the application layer 110 of the host. The external control commands are scheduled by the controller 120 according to the priority setting or the sequence in which they were received. In one embodiment, the controller 120 not only complies with the NVMe standard, but it also complies with the embedded MultiMediaCard (eMMC) standard, the Universal Flash Storage (UFS) standard, the Advanced Technology Attachment (ATA) standard, the Parallel ATA (PATA) standard, the Serial ATA (SATA) standard or the Small Computer System Interface (SCSI) standard. In another embodiment, the controller 120 includes an encryption mechanism to perform encryption on the data transmitted by the application layer 110, afterwards, it transmits or allocates the encrypted data to the flash memories 140A˜140D. For example, the above encryption mechanism could be the Advanced Encryption Standard (AES) or the RSA encryption. In addition to the encryption mechanism, the controller 120 further includes an inspecting mechanism to confirm the accuracy of data. The above inspection algorithm is preferably the Secure Hash Algorithm (SHA).

In one embodiment, when the data storage device 100 receives the control command from the application layer 110, the controller 120 assigns one of the working modes to one of the flash memories 140A˜140D during the on-the-fly period, or it switches the working mode of one of the flash memories 140A˜140D during the on-the-fly period. The above working mode could include the read-only mode, the write-only mode, the garbage collection off mode, the garbage collection switching mode, the garbage collection parameter modification mode, the wear-leveling off mode, or the over-provisioning parameter modification mode. For example, in order to support the garbage collection switching mode, at least two garbage-collection algorithms could be executed by the controller 120. When the garbage collection switching mode is performed, another garbage collection algorithm will be adopted by the controller 120 to replace the current garbage collection algorithm. When the number of spare blocks is less than the predetermined value, such as 20, the garbage collection procedure will be activated. The garbage collection parameter modification mode could be used to adjust the predetermined value. For example, the predetermined value could be increased to 50 or be decreased to 10. A certain portion of data storage capacity is usually reserved to be the over-provisioning for the data storage device. For example, the over-provisioning could be 5% of the data storage capacity. During the over-provisioning parameter modification mode, the data storage device 100 could merely reserve 2% of data storage capacity as the over-provisioning to provide more data storage capacity for the customer, or it could reserve 10% of data storage capacity as the over-provisioning. For example, the controller 120 makes the flash memory 140A operate at the read-only mode according to the control command, accesses the flash memory 140B in the write-only mode, operates the flash memories 140C˜140D in the garbage collection off mode, the garbage collection parameter modification mode or the wear-leveling off mode. Therefore, the data storage device 100 could respond to the control command of the application layer 110 of the host rapidly without being interfered by the garbage collection procedure or the wear-leveling procedure.

Regarding the read/write of data, the non-volatile storage of the data storage device 100 is operated by the controller 120 based on the received control command to temporarily store the control command received by the data storage device 100. Afterwards, the controller 120 converts the control command into the operation command, and executes the read/write operation on the flash memories 140A˜140D at proper timing based on the operation command. In another embodiment, the controller 120 converts the control command into the operation command directly, temporarily stores the operation command at the non-volatile storage, and executes the read/write operation on the flash memories 140A˜140D at proper timing based on the operation command.

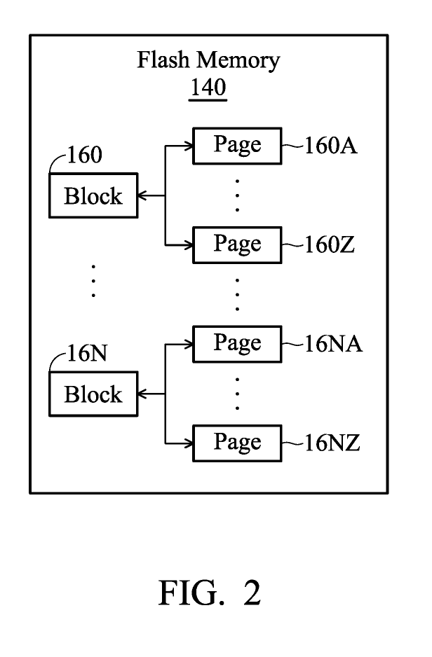

FIG. 2 is a schematic diagram illustrating the flash memory 140 according to an embodiment of the invention. The flash memory 140 includes several blocks 160˜16N. Each of the blocks 160˜16N includes several pages 160A˜16NZ. For example, the block 160 includes the pages 160A˜160Z, and the block 16N includes the pages 16NA˜16NZ. In addition, the controller 120 is coupled to the flash memory 140 to transmit data and commands, or to receive data and commands. For example, each of the blocks 160˜16N includes 256 pages. The size of each page is 16K bytes.

When the writing operation or storing operation is performed on the flash memory 140 by the controller 120, the data is written or programmed in units of physical pages by controlling the flash memory 140. The page is controlled by the word line. Regarding the flash memory 140, each physical page 160A˜16NZ of the blocks has a different physical address. When a data writing operation is performed by the data storage device 100, the controller 120 determines which physical address of the flash memory 140 to write data into. In addition, the controller 120 maps the above physical addresses to the respective logical addresses of the data, and develops a mapping table. In addition, if the page has extra space, the logical address of the data can be written to the page by the controller 120. Afterwards, the host reads the data stored in a logical address of the data storage device 100 through the logical address. Specifically, the controller 120 stores at least one mapping table H2F to record the mapping information between the logical addresses and the physical addresses of the flash memory 140.

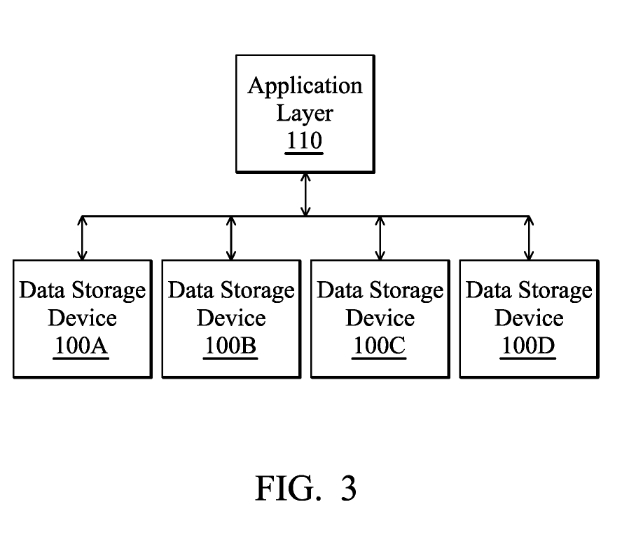

FIG. 3 is a block diagram illustrating the data storage devices 100A˜100D and the application layer 110 according to another embodiment of the invention. Each of the data storage devices 100A˜100D has a controller 120 and at least one flash memory 140 respectively. Specifically, the configurations of the data storage devices 100A˜100D are identical to the configuration of the data storage device 100 of FIG. 1, and will not be repeated. In one embodiment, several data storage devices 100A˜100D could be arranged as a Redundant Array of Independent Disks (RAID) to improve data reliability and performance when reading and writing data. In the first RAID mode, the data storage devices 100A˜100D are mirror mapping, whose stored data are the same. In the second embodiment, the data storage devices 100A˜100D store data individually. Specifically, some of the data storage devices 100A˜100D not only store data but also store the RAID parity code. Several RAID modes could be provided for the customer by the data storage devices 100A˜100D.

It should be noted that the data storage devices 100A˜100D could be mutually independent. The working mode of each of the data storage devices 100A˜100D could be adjusted individually. For example, the customer wants to move the data stored at the data storage device 100A to the data storage device 100D. Accordingly, the control command is transmitted by the application layer 110 to set the data storage device 100A as the read-only mode and set the data storage device 100D as the write-only mode. Because the read only function is activated when operating the data storage device 100A, the controller 120 of the data storage device 100A does not amend the mapping table H2F related to the flash memory 140. Furthermore, the write only function is activated when operating the data storage device 100D, the controller 120 of the data storage device 100D amends the mapping table H2F related to the flash memory 140 to record the physical address of the written data.

Because each data storage device 100A˜100D and its flash memory 140 could be mutually independent, the working state can be rapidly and effectively adjusted individually according to the needs of the user. For example, when a working mode (such as the read-only mode) is set for the data storage device 100A, it is not needed to reserve resources for executing other working procedures, such as the garbage collection procedure and the wear-leveling procedure. Therefore, the data reading could be performed with better efficiency by the data storage device 100A. By utilizing the data storage device and the data storage method of the present invention, the working mode can be switched rapidly during operation based on the needs of user to improve the working performance. In addition, the setting of the working mode is convenient for the management of data. For example, in the read-only mode, the user can read confidential data but cannot amend or update confidential data.

The garbage collection procedure or the wear-leveling procedure is usually initiated in the background, which means that the host is idle or leisure. However, when specific conditions are met, such as the number of spare blocks being less than the predetermined value, the controller 120 will enforce to enter into the background and initiate the garbage collection procedure. However, when the application layer 110 of the host needs to read a lot of data or write high-priority data, initiating the garbage collection procedure will result in decreasing system performance. Therefore, turning off the garbage collection procedure or the wear-leveling procedure temporarily, or switching to the garbage collection parameter modification mode to adjust the predetermined value, could be helpful to enhancing the system performance. For example, during the garbage collection parameter modification mode, the predetermined value is adjusted to 100 so that the data storage device 100 can have more spare blocks. In another embodiment, the controller 120 has activated the garbage collection procedure or the wear-leveling procedure, after leave of the garbage collection close mode or the wear-leveling close mode. The controller 120 can skip the garbage collection procedure or the wear-leveling procedure to improve system performance temporarily.

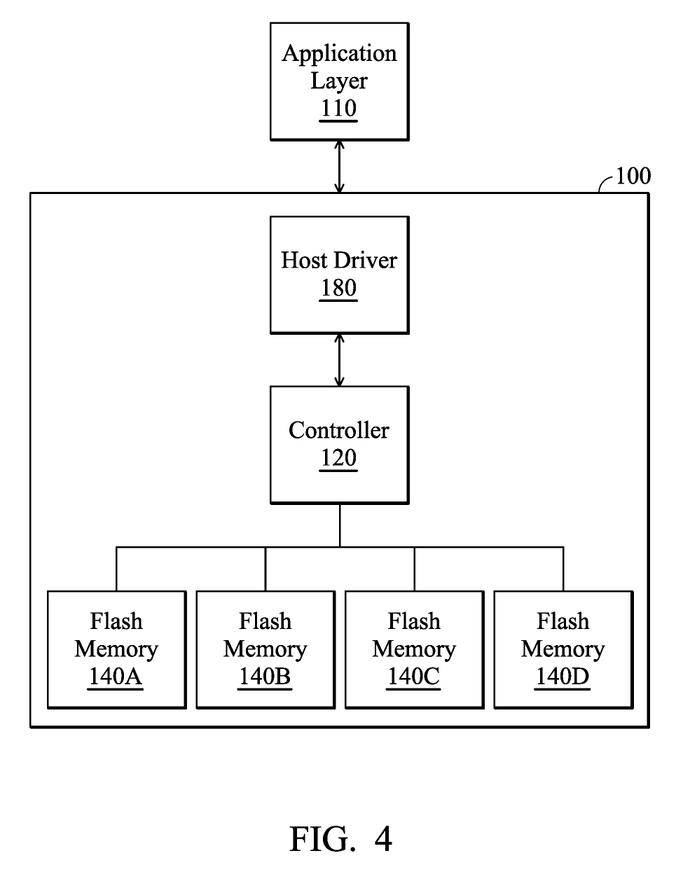

FIG. 4 is a block diagram illustrating the data storage device 100 and the application layer 110 according to another embodiment of the invention. The embodiment of FIG. 4 belongs to the software defined architecture. The difference between the embedded architecture of FIG. 4 and that of FIG. 1 is that the data storage device 100 further includes a host driver 180. The host driver 180 is arranged between the controller 120 and the application layer 110 in order to apply the working mode to the flash memory 140 based on the control command of the application layer 110 or switch the working mode of the flash memory based on the control command. In addition, the mapping table H2F could be stored at the host driver 180.

Compared to the embedded architecture of FIG. 1, the host driver 180 of the software defined architecture of FIG. 4 could store the mapping table H2F, manage the logical addresses of the flash memory, and request to switch the working mode during operation according to the control command. At the software defined architecture of FIG. 4, the controller 120 does not need to switch the working mode and store the mapping table H2F. The controller 120 is responsible for managing the flash memory 140 and accessing data. In other words, the function of the controller 120 of FIG. 4 is simpler than the function of the controller 120 of FIG. 1. Therefore, the controller 120 of FIG. 4 is able to manage more flash memories 140. In addition, since the host driver 180 can store the mapping table H2F and manage the logical addresses of the flash memory, a faster access speed could be achieved when the data storage device 100 of FIG. 4 is accessed by an external device or the host.

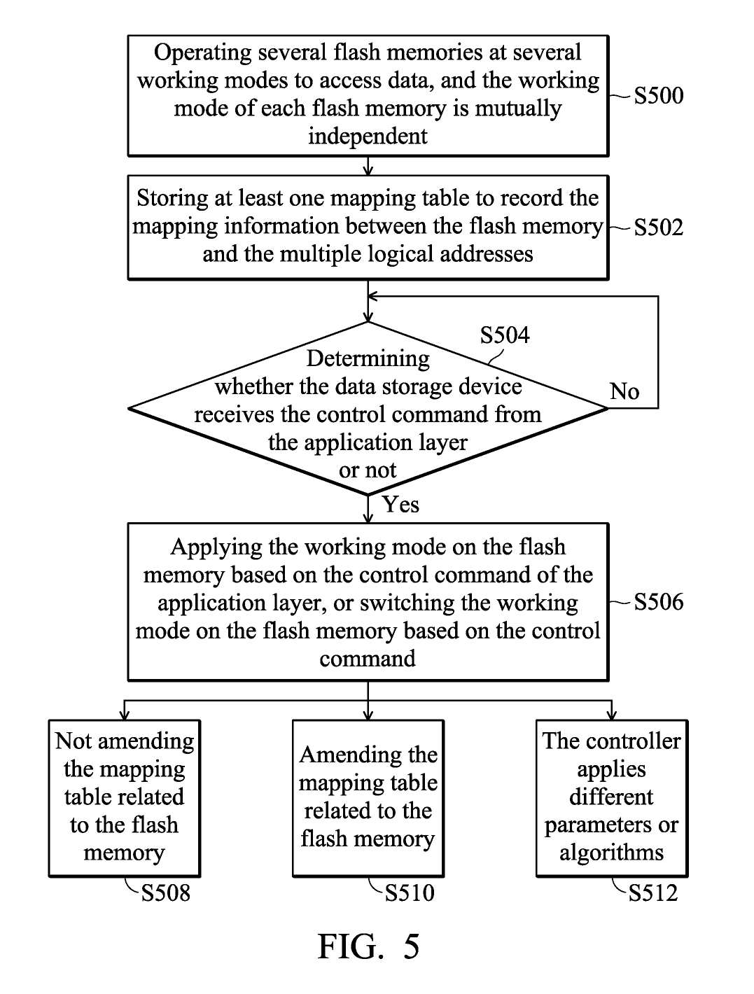

FIG. 5 is a process flow illustrating the data storage method according to an embodiment of the invention. It should be noted that the data storage method of the present invention could be applied at the embedded architecture of FIG. 1, the software defined architecture of FIG. 4 or the data storage device of other similar architecture, which is not limited by the present invention.

In step S500, Several flash memories 140 are able to be operated in several working modes to access data. The working mode of each flash memory 140 is mutually independent. In step S502, at least one mapping table H2F is stored to record the mapping information between the flash memory 140 and the multiple logical addresses. In step S504, whether the data storage device 100 receives the control command from the application layer 110 or not is determined.

If the data storage device 100 does not receive the control command from the application layer 110, step S504 will be executed again. If the data storage device 100 receives the control command from the application layer 110, step S506 will be executed that the controller 120 applies the working mode on the flash memory 140 based on the control command of the application layer 110 or switches the working mode on the flash memory 140 based on the control command. The above working mode could include the read-only mode, the write-only mode, the garbage collection off mode, the garbage collection switching mode, the garbage collection parameter modification mode, the wear-leveling off mode or the over-provisioning parameter modification mode.

If the read-only mode is executed, step S508 will be executed that the controller 120 does not amend the mapping table H2F related to the flash memory 140. If the write-only mode, the garbage collection close mode or the wear-leveling off mode is executed, step S510 will be executed that the controller 120 amends the mapping table H2F related to the flash memory 140. In other working modes, step S512 will be executed that the controller 120 applies different parameters or algorithms. For example, in the garbage collection algorithm switch mode, the controller 120 applies another garbage collection algorithm when initiating the garbage collection procedure. In the garbage collection parameter modification mode, the controller 120 will increase or decrease the predetermined value which is the determination basis for initiating the garbage collection procedure. At the over-provisioning parameter modification mode, the controller 120 will adjust the over-provisioning parameter, such as 10% or 2%.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Therefore, the scope of the appended claims should be accorded the broadest interpretation so as to encompass all such modifications and similar arrangements.

What is claimed is:

1. A data storage device, comprising:
a plurality of flash memories, wherein each of the flash memories comprises a plurality of blocks; and
at least one controller, operating the flash memories to access data in a plurality of working modes, wherein the working mode of each flash memory is mutually independent, and when the data storage device receives a control command from an application layer, the controller applies one of the working modes to one of the flash memories during operation, or switches the working mode of one of the flash memories during operation according to the control command.

2. The data storage device as claimed in claim 1, wherein the working mode comprises a read-only mode, a write-only mode, a garbage collection off mode, a garbage collection switching mode, a garbage collection parameter modification mode, a wear-leveling off mode or an over-provisioning parameter modification mode.

3. The data storage device as claimed in claim 1, wherein the controller stores at least one mapping table to record mapping information between the flash memory and a plurality of logical addresses.

4. The data storage device as claimed in claim 2, wherein when the read-only mode is applied to the flash memory, the controller does not amend the mapping table related to the flash memory; and when the write-only mode is applied to the flash memory, the controller amends the mapping table related to the flash memory.

5. The data storage device as claimed in claim 2, wherein the garage collection

6. The data storage device as claimed in claim 2, wherein the wear-leveling close mode does not initiate or stop execution of a wear-leveling procedure.

7. The data storage device as claimed in claim 2, wherein the garbage collection switch mode is utilized to switch an algorithm executable in a garbage collection procedure.

8. The data storage device as claimed in claim 2, wherein the garbage collection parameter modification mode is utilized to adjust a predetermined value which is referred by a garbage collection procedure.

9. The data storage device as claimed in claim 2, wherein: the over-provisioning parameter modification mode is utilized to adjust a data storage capacity for an over provisioning.

10. The data storage device as claimed in claim 1, wherein: the controller applies one of the working modes to one of the flash memories during operation according to the control command, or switches the working mode of one of the flash memories during operation according to the control command.

11. The data storage device as claimed in claim 1, further comprising:
a host driver, arranged between the controller and the application layer, utilized to apply one of the working modes to one of the flash memories during operation, or switch the working mode of one of the flash memories during operation according to the control command.

12. A data storage method applied to a data storage device, the data storage device comprising a plurality of flash memories and at least one controller, the data storage
arranging the flash memories to access data at a plurality of working modes, wherein the working mode of each flash memory is mutually independent;
determining whether the data storage device receives a control command from an application layer or not; and
when receiving the control command, applying one of the working modes for one of the flash memories during operation, or switching the working mode of one of the flash memories during operation according to the control command.

13. The data storage method as claimed in claim 12, wherein the working mode comprises a read-only mode, a write-only mode, a garbage collection off mode, a garbage collection switching mode, a garbage collection parameter modification mode, a wear-leveling off mode or an over-provisioning parameter modification mode.

14. The data storage method as claimed in claim 12, further comprising:
storing at least one mapping table to record mapping information between the flash memory and a plurality of logical addresses.

15. The data storage method as claimed in claim 12, wherein when the read-only mode is applied to the flash memory, not amending the mapping table related to the flash memory; and when the write-only mode is applied to the flash memory, amending the mapping table related to the flash memory.

16. The data storage method as claimed in claim 12, wherein the garage collection close mode does not initiate or stop execution of a garbage collection procedure.

17. The data storage method as claimed in claim 12, wherein the wear-leveling

18. The data storage method as claimed in claim 12, wherein the garbage collection switch mode is utilized to switch an algorithm executable in a garbage collection procedure.

19. The data storage method as claimed in claim 12, wherein the garbage collection parameter modification mode is utilized to adjust a predetermined value which is referred by a garbage collection procedure.

20. The data storage method as claimed in claim 12, wherein the over-provisioning parameter modification mode is utilized to adjust the data storage capacity for over provisioning.

21. The data storage method as claimed in claim 12, wherein:
a host driver is arranged between the controller and the application layer; and
one of the working modes is applied to one of the flash memories during operation, or the working mode of one of the flash memories is switched
